(19) United States
(12) Patent Application Publication
(10) Pub. No.: US 2026/0314887 A1
(43) Pub. Date: Oct. 15, 2026

(54) DOCK PERIPHERY CLEANING METHOD AND APPARATUS, CLEANING DEVICE AND COMPUTER-READABLE STORAGE MEDIUM

(71) Applicant: Beijing Roborock Innovation Technology Co., Ltd., Beijing (CN)

(72) Inventors: Jian SONG, Beijing (CN); Lei WANG, Beijing (CN)

(73) Assignee: Beijing Roborock Innovation Technology Co., Ltd., Beijing (CN)

(21) Appl. No.: 19/574,041

(22) Filed: Mar. 20, 2026

Related U.S. Application Data
(63) Continuation of application No. PCT/CN2024/109167, filed on Aug. 1, 2024.

(30) Foreign Application Priority Data
Sep. 28, 2023 (CN) 202311278387.2

(51) Int. Cl. A47L 9/28

(52) U.S. Cl. CPC A47L 9/2826; A47L 2201/022; A47L 2201/04; A47L 2201/06

(57) ABSTRACT

A dock periphery cleaning method includes: detecting whether a dock region in which a charging dock of a cleaning device is located has an intersection with a cleaned region; and if the dock region has the intersection with the cleaned region, performing cleaning based on peripheral points of the dock region.

This application is a continuation of International Application No. PCT/CN2024/109167, with an international filling date of Aug. 1, 2024, which claims priority to Chinese Patent Application No. 202311278387.2, filed on Sep. 28, 2023, the entire contents of which are incorporated herein by reference in its entirety.

### TECHNICAL FIELD

The present disclosure relates to the technical field of smart appliances, and in particular, to a dock periphery cleaning method and apparatus, a cleaning device, and a computer-readable storage medium.

### BACKGROUND ART

After automatic cleaning, cleaning devices such as sweepers, mopping machines, and floor-cleaning machines often need to automatically return to charging docks adapted to the cleaning devices for charging. A region in which a charging dock is located, i.e., a dock region, is generally set as a no-go region for the cleaning device.

### SUMMARY OF THE INVENTION

In a first aspect, the embodiments of the present disclosure provide a dock periphery cleaning method. The dock periphery cleaning method includes: detecting whether a dock region in which a charging dock of a cleaning device is located has an intersection with a cleaned region; and if the dock region has the intersection with the cleaned region, performing cleaning based on peripheral points of the dock region.

In a second aspect, the embodiments of the present disclosure provide a cleaning device. The cleaning device includes: at least one processor; and a memory communicatively connected to the at least one processor, where the memory stores instructions executable by the at least one processor, and the instructions are configured for performing the method according to the first aspect.

In a third aspect, the embodiments of the present disclosure provide a computer-readable storage medium storing computer-executable instructions. The computer-executable instructions are used for performing the method according to the first aspect.

### BRIEF DESCRIPTION OF THE DRAWINGS

For clearer descriptions of the technical solutions in embodiments of the present disclosure, the drawings required to be used in the embodiments are briefly introduced below. It is apparent that the drawings in the description below are only some embodiments of the present disclosure, and for those of ordinary skill in the art, other drawings may be obtained from the drawings presented in this application.

FIG. 1 shows a schematic diagram of a cleaning path of a cleaning device being blocked by an obstacle around a dock region in the related art;

FIG. 2 shows a schematic diagram of a cleaning path of another cleaning device being blocked by an obstacle around a dock region in the related art;

FIG. 3 shows a flowchart of a dock periphery cleaning method according to an embodiment of the present disclosure;

FIG. 4 shows a flowchart of a dock periphery cleaning method according to another embodiment of the present disclosure;

FIG. 5 shows a flowchart of a dock periphery cleaning method according to yet another embodiment of the present disclosure;

FIG. 6 shows a block diagram of a dock periphery cleaning apparatus according to an embodiment of the present disclosure;

FIG. 7 shows a block diagram of a computer device according to an embodiment of the present disclosure; and

FIG. 8 shows a block diagram of a computer device according to an embodiment of the present disclosure.

### DETAILED DESCRIPTION

The technical solutions in embodiments of the present disclosure will be clearly and completely described hereinafter with reference to the drawings in the embodiments of the present disclosure. It is apparent that the described embodiments are some, but not all, embodiments of the present disclosure. Based on the embodiments of the present disclosure, all other embodiments obtained by those of ordinary skill in the art shall fall within the protection scope of the present disclosure.

After automatic cleaning, cleaning devices such as sweepers, mopping machines, and floor-cleaning machines often need to automatically return to charging docks adapted to the cleaning devices for charging. A region in which a charging dock is located, i.e., a dock region, is generally set as a no-go region for the cleaning device. On this basis, if there is an obstacle around the charging dock, the cleaning device, hindered by both the dock region and the obstacle, may easily miss the region that should be cleaned near the dock region during cleaning.

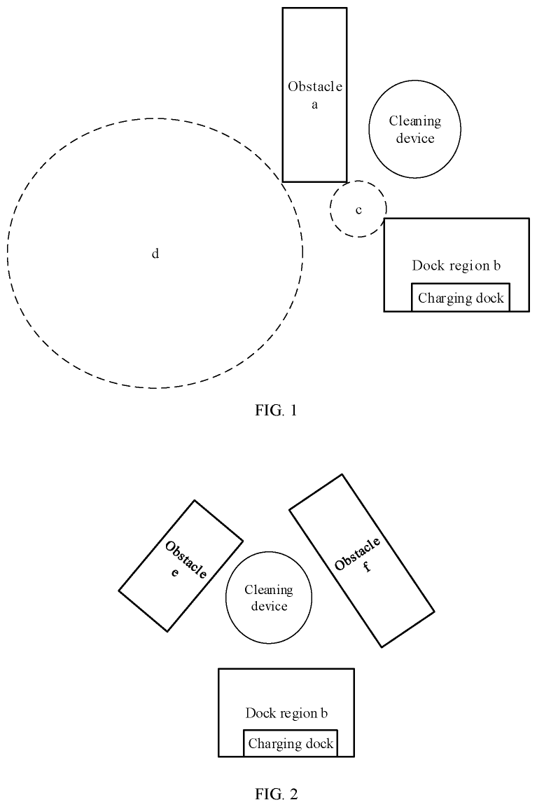

In a possible scenario, as shown in FIG. 1, there is an obstacle a in front of the charging dock, and a dock region in which the charging dock is located is b. After leaving the dock, the cleaning device performs cleaning and travels to a position c near the dock region b along the obstacle a. Since the distance between the obstacle a and the edge of the dock region b at the position c is less than the maximum body width of the cleaning device, the movement of the cleaning device is limited, preventing the cleaning device from passing through the position c to clean a region d in the figure. This results in the cleaning device missing the region d.

In another possible scenario, as shown in FIG. 2, a dock region in which the charging dock is located is b, there are obstacles e and f on two sides of the front of the charging dock, and the cleaning device performs cleaning after leaving the dock. Due to the influence of the obstacles e and f and the fact that the distance between each of the obstacles e and f and the edge of the dock region b is less than the maximum body width of the cleaning device, the cleaning device cannot pass through the gap between the obstacle e and the dock region b, nor through the gap between the obstacle f and the dock region b. Finally, the cleaning region is limited to a small region in front of the dock region b before the cleaning device has to return to the charging dock, leading to a very small cleaning area and poor cleaning effect.

In view of the above, a dock region with an obstacle near the dock region usually affects the normal cleaning traveling route of the cleaning device, such that the cleaning device misses cleanable regions, thereby reducing the cleaning area, and affecting the final cleaning effect.

Therefore, how to prevent the cleaning device from missing the cleanable region due to the obstacle around the dock region has become an urgent technical problem to be solved.

Embodiments of the present disclosure provide a dock periphery cleaning method and apparatus, a cleaning device, and a computer-readable storage medium, which are intended to solve the technical problem in the related art that a cleaning device misses a cleanable region due to an obstacle around a dock region.

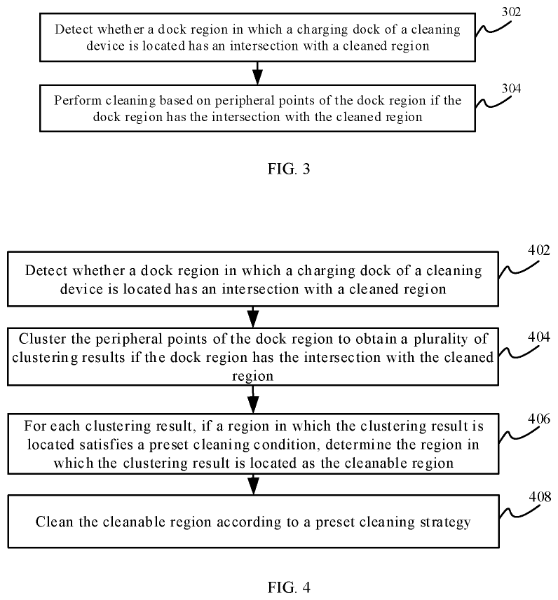

FIG. 3 shows a flowchart of a dock periphery cleaning method according to an embodiment of the present disclosure.

As shown in FIG. 3, the dock periphery cleaning method according to an embodiment of the present disclosure includes the following steps.

In step 302, whether a dock region in which a charging dock of a cleaning device is located has an intersection with a cleaned region is detected.

The cleaned region is a region that has been cleaned by the cleaning device. Based on the above descriptions in the background section, it can be seen that if an obstacle is present in the region around the dock region, the cleaning device may easily miss a cleanable region. Therefore, after the cleaning of the cleaned region is completed, whether the cleaned region is an adjacent region of the dock region may be identified by determining whether the cleaned region has an intersection with the dock region.

In a possible design, the cleaned region is the entire region that has been cleaned by the cleaning device in a current cleaning process.

In another possible design, the cleaned region is any zone of the cleaning device that has been cleaned among a plurality of cleaning zones in a current cleaning process. Further, in some embodiments, the cleaned region is a current cleaning zone that has been cleaned by the cleaning device in real time. In this way, each time the cleaning device completes the cleaning of one cleaning zone, it is detected whether there is a missed cleanable region due to an obstacle in the region around the dock region, such that supplementary cleaning is performed on the missed cleanable region in time in the overall cleaning process, thereby reducing the path length of the cleaning device in the supplementary cleaning process and reducing the power loss.

In still another possible design, the cleaned region is the entire region or a cleaning zone on which the cleaning device has performed cleaning in a historical cleaning process, such that the cleaning device performs supplementary cleaning on a missed cleanable region in the historical cleaning process, thereby improving the cleaning effect.

In step 304, if the dock region has the intersection with the cleaned region, cleaning is performed based on peripheral points of the dock region.

If the dock region in which the charging dock of the cleaning device is located has an intersection with the cleaned region, it indicates that the cleaned region is adjacent to the dock region. In this case, there is a possibility that an obstacle is present in the region around the dock region, and accordingly, there is a possibility that the cleaning device misses a cleanable region due to the dual obstructions of the dock region and the obstacle near the dock region. Therefore, in the case that the dock region in which the charging dock of the cleaning device is located has an intersection with the cleaned region, further cleaning may be triggered, so as to perform supplementary cleaning on the cleanable region when a missed cleanable region is present.

Certainly, if the dock region in which the charging dock of the cleaning device is located has no intersection with the cleaned region, it indicates that the cleaned region is not adjacent to the dock region, and there is no possibility that a cleanable region is missed due to the dual obstructions of the dock region and the obstacle near the dock region, and the next cleaning process can be normally performed.

Further, the peripheral points of the dock region can reflect an important feature of whether an obstacle is present around the dock region. Therefore, based on the peripheral points of the dock region, the cleanable region that is missed due to the dual obstructions of the dock region and the obstacle around the dock region may be determined.

According to the above technical solutions, in view of the technical problem in the related art that a cleaning device misses a cleanable region due to an obstacle around a dock region, whether a cleaned region is a dock periphery region is identified by identifying whether the dock region in which the charging dock of the cleaning device is located has an intersection with the cleaned region. As a result, when the cleaned region is the dock periphery region, dock region peripheral points that can reflect whether an obstacle is present around the dock region are used to determine a cleanable region that is missed due to the dual obstructions of the dock region and the obstacle near the dock region. Therefore, the method can automatically identify the cleanable region that is missed during cleaning due to the dual obstructions of the dock region and the obstacle near the dock region, thereby improving the adaptability of the cleaning device to the cleaning environment when there is an obstacle around the dock periphery, increasing the cleaning area of the cleaning device, and effectively improving the cleaning capability of the cleaning device. In addition, the overall cleaning effect is improved, and the user experience is enhanced.

Specifically, it may determine a cleanable region based on the peripheral points of the dock region, and then clean the cleanable region according to a preset cleaning strategy, so as to perform supplementary cleaning on the cleanable region, thereby improving the adaptability of the cleaning device to the environment, and resulting in an excellent cleaning effect.

In a possible design, the peripheral points of the dock region may be directly connected in pairs to form a peripheral region. If the maximum width of the peripheral region is greater than the maximum body width of the cleaning device, it indicates that the cleaning device can pass through the peripheral region, and the peripheral region is determined as a cleanable region, such that the cleaning device moves to the peripheral region for supplementary cleaning.

In another possible design, the peripheral points may be clustered, and the cleaning feasibility of each obtained clustering result is determined. This solution is described in detail below with reference to FIG. 4.

As shown in FIG. 4, the dock periphery cleaning method according to another embodiment of the present disclosure includes the following steps.

In step 402, whether a dock region in which a charging dock of a cleaning device is located has an intersection with a cleaned region is detected.

In step 404, if the dock region has the intersection with the cleaned region, the peripheral points of the dock region are clustered to obtain a plurality of clustering results.

If the dock region in which the charging dock of the cleaning device is located has an intersection with the cleaned region, it indicates that the cleaned region is adjacent to the dock region. In this case, there is a possibility that an obstacle is present in the region around the dock region, and accordingly, there is a possibility that the cleaning device misses a cleanable region due to the dual obstructions of the dock region and the obstacle near the dock region. Since the peripheral points of the dock region reflect an important feature of whether an obstacle is present around the dock region, there is a possibility that the region in which the peripheral point is located is a missed cleanable region.

At this point, the peripheral points of the dock region are clustered to obtain the plurality of clustering results, and there is a possibility that each region in which a clustering result is located is a missed cleanable region.

In some embodiments, a manner of clustering the peripheral points includes, but is not limited to, any computational manner capable of clustering the points, such as a k-means clustering algorithm, a k-means++ clustering algorithm, a bi-kmeans clustering algorithm, a kernel k-means clustering algorithm, a DBSCAN clustering algorithm, and an OPTICS clustering algorithm.

In step 406, for each clustering result, if a region in which the clustering result is located satisfies a preset cleaning condition, the region in which the clustering result is located is determined as the cleanable region.

The preset cleaning condition is used to reflect the feature of the region in which the clustering result is located when the region in which the clustering result is located can be effectively cleaned by the cleaning device. If one clustering result satisfies the preset cleaning condition, it indicates that the region in which the clustering result is located can be effectively cleaned by the cleaning device. Therefore, the region in which the clustering result is located can be determined as the cleanable region.

Further, the preset cleaning condition includes one or more of the following: The width of the region in which the clustering result is located in at least one direction is greater than the maximum body width of the cleaning device; the area of an uncleaned region in the region in which the clustering result is located is greater than or equal to a first specified area; the area of a cleaned region in the region in which the clustering result is located is less than or equal to a second specified area; and the region in which the clustering result is located includes at least a specified number of points at a distance from the obstacle greater than or equal to a third specified distance.

The width of the region in which the clustering result is located in at least one direction is greater than the maximum body width of the cleaning device, indicating that the region in which the clustering result is located can accommodate the passage of the cleaning device in at least one direction, which is a necessary condition for effective cleaning.

The first specified area is the minimum area of a region that is large enough for the cleaning device to perform supplementary cleaning. If the area of the uncleaned region in the region in which the clustering result is located is greater than or equal to the first specified area, it indicates that the region in which the clustering result is located is sufficiently large and requires supplementary cleaning.

The second specified area is, when a region requires supplementary cleaning by the cleaning device, the maximum area of the cleaned area within the region. If the area of the cleaned region in the region in which the clustering result is located is less than or equal to the second specified area, it indicates that although the region in which the clustering result is located has a cleaned part, the remaining part is still sufficiently large and requires supplementary cleaning.

The third specified distance refers to the minimum distance between a point and an obstacle when the point can be effectively cleaned without being affected by the obstacle. If the region in which the clustering result is located includes at least a specified number of points at a distance from the obstacle greater than or equal to the third specified distance, it indicates that the region in which the clustering result is located has a sufficient number of points far enough away from the obstacle, and the region meets the necessary condition for being effectively cleaned by the cleaning device.

In some embodiments, the first specified area is 10 cm², 30 cm², or 50 cm².

In some embodiments, the second specified area is 5 cm², 25 cm², or 10 cm².

In some embodiments, the specified number is 30, 45, or 70.

In some embodiments, the third specified distance is 0.5 cm, 1 cm, or 1.5 cm.

Certainly, the above numerical values may be any values that meet actual cleaning requirements, and are not limited to the foregoing examples.

In step 408, the cleanable region is cleaned according to a preset cleaning strategy.

The preset cleaning strategy refers to a preset manner for performing supplementary cleaning on a cleanable region that is missed during cleaning. The cleanable region is cleaned according to the preset cleaning strategy, such that supplementary cleaning on the cleanable region that is missed due to the dual obstructions of the dock region and the obstacle near the dock region can be achieved, thereby improving the adaptability of the cleaning device to the cleaning environment when there is an obstacle around the dock periphery, increasing the cleaning area of the cleaning device, and effectively improving the cleaning capability of the cleaning device. In addition, the overall cleaning effect is improved, and the user experience is enhanced.

Specifically, the preset cleaning strategy includes: performing a cross-region action on the cleanable region; and cleaning the cleanable region when the cross-region action is successfully performed.

The cross-region action refers to a traveling operation of the cleaning device from a currently cleaned region to another uncleaned region. When the cross-region action is successfully performed, it indicates that the cleaning device successfully enters the cleanable region. In this case, supplementary cleaning may be directly performed on the cleanable region.

When the cross-region action fails to be performed, the process returns to the step of detecting whether the dock region in which the charging dock of the cleaning device is located has the intersection with the cleaned region, so as to determine again whether the cleanable region is present around the dock region; and the cleanable region is cleaned when it is determined again that the cleanable region is present around the dock region.

In this case, the cross-region action fails to be performed, indicating that the cleanable region may not accommodate the smooth passage of the cleaning device due to factors such as an excessively small length of the cleanable region in the traveling direction of the cleaning device. In this case, the cleanable region may be re-determined.

Cleaning the cleanable region when it is determined again that the cleanable region is present around the dock region includes: acquiring an uncleaned region within a specified distance range centered at the current position of the cleaning device; and cleaning the cleanable region if an area of the uncleaned region is greater than or equal to a third specified area.

That is, the cleanable region near the cleaning device is cleaned only when the uncleaned region near the cleaning device is large enough. The third specified area refers to the minimum area of the cleanable region when the cleaning is necessary, and may be 50 cm², 80 cm², or 90 cm². Certainly, the third specified area may be any area that meets the actual cleaning requirements, and is not limited to the foregoing examples.

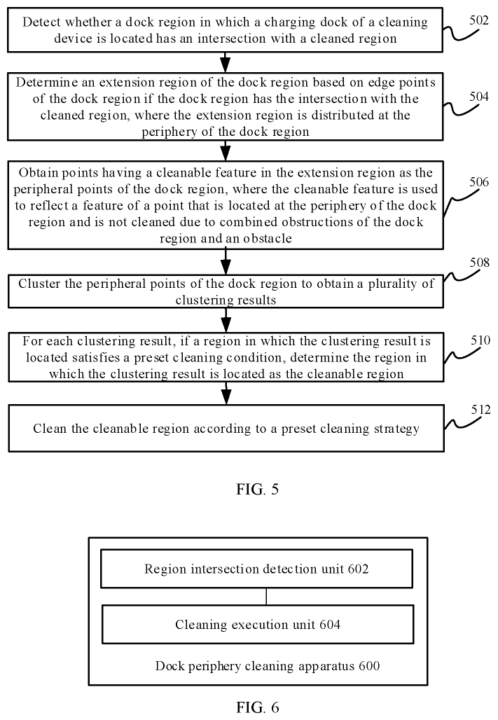

In any one of the above embodiments, for example, the adjacent points of the dock region may be randomly selected as the peripheral points of the dock region, or points between the dock region and an obstacle around the dock may be randomly selected as the peripheral points of the dock region. As shown in FIG. 5, the dock periphery cleaning method according to yet another embodiment of the present disclosure includes the following steps.

In step 502, whether a dock region in which a charging dock of a cleaning device is located has an intersection with a cleaned region is detected.

In step 504, if the dock region has the intersection with the cleaned region, an extension region of the dock region is determined based on edge points of the dock region, where the extension region is distributed at the periphery of the dock region.

In the extension region of the dock region, there may be a cleanable region that is missed due to the dual obstructions of the dock region and the obstacle near the dock region.

In a possible design, the extension region is obtained by extending each edge point of the dock region by a second specified distance in a direction perpendicular to a corresponding edge.

In a possible design, the extension region is obtained by extending each edge point of the dock region by the second specified distance in a direction that is offset by 30° clockwise from the direction perpendicular to the corresponding edge.

The second specified distance may be any distance greater than the maximum body width of the cleaning device. In this way, it indicates that the width of the extension region can accommodate the passage of the cleaning device body. A region can be cleaned only when the cleaning device can pass through the region. Therefore, the second specified distance may be any distance greater than the maximum body width of the cleaning device, which meets the necessary condition for the cleaning device to perform supplementary cleaning on the extension region.

In some embodiments, the second specified distance is 35 cm, 45 cm, or 48 cm. Certainly, the numerical value may be any value that meets the actual cleaning requirements, and is not limited to the foregoing examples.

In step 506, points having a cleanable feature in the extension region are obtained as the peripheral points of the dock region, where the cleanable feature is used to reflect the feature of a point that is located at the periphery of the dock region and is not cleaned due to the combined obstructions of the dock region and an obstacle.

The cleanable feature includes one or more of the following: The width of an uncleaned region in at least one direction of a position where the point is located is greater than the maximum body width of the cleaning device; the point is an uncleaned non-obstacle point; all the adjacent points of the point are uncleaned non-obstacle points; and the point is outside a preset no-go region, the preset no-go region including a carpet region, the dock region, and a self-defined safety region.

The width of the uncleaned region in at least one direction of the position where the point is located is greater than the maximum body width of the cleaning device, indicating that the position where the point is located can accommodate the smooth passage of the cleaning device, which is a basis for effective cleaning. Filtering out uncleaned non-obstacle points can avoid repeated cleaning of cleaned points, reducing repeated work by the cleaning device. Further, if all the adjacent points of a point are uncleaned non-obstacle points, it indicates that both the cleaning feasibility and the need for cleaning in the region where the point is located are sufficiently high. In addition, the point is outside the preset no-go region, which can prevent the movement of the cleaning device from being restricted by the preset no-go region, thereby avoiding the impact on the supplementary cleaning effect. The preset no-go region includes but is not limited to a carpet region, the dock region, and a self-defined safety region.

In step 508, the peripheral points of the dock region are clustered to obtain a plurality of clustering results.

In step 510, for each clustering result, if a region in which the clustering result is located satisfies a preset cleaning condition, the region in which the clustering result is located is determined as the cleanable region.

In step 512, the cleanable region is cleaned according to a preset cleaning strategy.

The preset cleaning condition is used to reflect the feature of the region in which the clustering result is located when the region in which the clustering result is located can be effectively cleaned by the cleaning device. If one clustering result satisfies the preset cleaning condition, it indicates that the region in which the clustering result is located can be effectively cleaned by the cleaning device. Therefore, the region in which the clustering result is located can be determined as the cleanable region.

The preset cleaning strategy refers to a preset manner for performing supplementary cleaning on a cleanable region that is missed during cleaning. The cleanable region is cleaned according to the preset cleaning strategy, such that supplementary cleaning on the cleanable region that is missed due to the dual obstructions of the dock region and the obstacle near the dock region can be achieved, thereby improving the adaptability of the cleaning device to the cleaning environment when there is an obstacle around the dock periphery, increasing the cleaning area of the cleaning device, and effectively improving the cleaning capability of the cleaning device. In addition, the overall cleaning effect is improved, and the user experience is enhanced.

Based on any one of the above embodiments, in a possible design, the method of detecting whether the dock region in which the charging dock of the cleaning device is located has the intersection with the cleaned region may be selected as follows: detecting, when the cleaning of a first region is completed, whether the first region has an intersection with the dock region in which the charging dock of the cleaning device is located.

The first region is a region in the cleaning process of the cleaning device that has the possibility of requiring supplementary cleaning.

In some embodiments, the user may manually select a region that has the possibility of being missed during cleaning or a region that has been missed during cleaning in a historical cleaning process as the first region.

In some embodiments, all cleaned regions in the current cleaning process are set as the first region, so as to check the necessity of overall supplementary cleaning for all the cleaned regions.

In another possible design, the method of detecting whether the dock region in which the charging dock of the cleaning device is located has the intersection with the cleaned region may be selected as follows: detecting, when the cleaning of a plurality of second regions is completed, whether at least one second region has an intersection with the dock region in which the charging dock of the cleaning device is located.

All regions to be cleaned are divided into a plurality of cleaning zones in the cleaning process of the cleaning device. The second region refers to a single cleaning zone in the cleaning process of the cleaning device. In this way, after cleaning any cleaning zone, the cleaning device may perform supplementary cleaning necessity detection on the cleaning zone and/or another cleaning zone that has been cleaned before the cleaning zone in time, so as to discover a missed cleanable region in time during the cleaning process, and perform supplementary cleaning on the missed cleanable region in time.

In yet another possible design, the method of detecting whether the dock region in which the charging dock of the cleaning device is located has the intersection with the cleaned region may be selected as follows: detecting, when the cleaning of a third region including a specified point is completed, whether the third region has an intersection with the dock region in which the charging dock of the cleaning device is located.

The specified point is a point outside the dock region and whose distance from an edge point of the dock region is less than or equal to a first specified distance. In some embodiments, the first specified distance is 0.5 cm, 1 cm, or 1.5 cm. Certainly, the numerical value may be any value that meets the actual cleaning requirements, and is not limited to the foregoing examples.

That is, detection of the necessity of supplementary cleaning may be performed on the designated dock periphery region in a targeted manner, so as to promptly identify a cleanable region that is missed due to the dual obstructions of the dock region and the obstacle near the dock region.

FIG. 6 shows a block diagram of a dock periphery cleaning apparatus according to an embodiment of the present disclosure.

As shown in FIG. 6, the dock periphery cleaning apparatus 600 according to an embodiment of the present disclosure includes: a region intersection detection unit 602, configured to detect whether a dock region in which a charging dock of a cleaning device is located has an intersection with a cleaned region; and a cleaning execution unit 604, configured to perform cleaning based on the peripheral points of the dock region if the dock region has the intersection with the cleaned region.

In an embodiment of the present disclosure, for example, the cleaning execution unit 604 includes: a cleanable region determination unit, configured to determine a cleanable region based on the peripheral points of the dock region. The cleaning execution unit is configured to clean the cleanable region according to a preset cleaning strategy.

In an embodiment of the present disclosure, for example, the cleanable region determination unit is configured to: cluster the peripheral points of the dock region to obtain a plurality of clustering results; and for each clustering result, if a region in which the clustering result is located satisfies a preset cleaning condition, determine the region in which the clustering result is located as the cleanable region, where the preset cleaning condition is used to reflect a feature of the region in which the clustering result is located when the region in which the clustering result is located can be effectively cleaned by the cleaning device.

In an embodiment of the present disclosure, for example, the region intersection detection unit 602 is configured to: detect, when the cleaning of a first region is completed, whether the first region has an intersection with the dock region in which the charging dock of the cleaning device is located; or detect, when the cleaning of a plurality of second regions is completed, whether at least one second region has an intersection with the dock region in which the charging dock of the cleaning device is located; or detect, when the cleaning of a third region including a specified point is completed, whether the third region has an intersection with the dock region in which the charging dock of the cleaning device is located, where the specified point is a point outside the dock region and whose distance from an edge point of the dock region is less than or equal to a first specified distance.

In an embodiment of the present disclosure, for example, the dock periphery cleaning apparatus 600 also includes: an extension region determination unit, configured to determine the extension region of the dock region based on the edge points of the dock region before clustering the peripheral points of the dock region if the dock region has the intersection with the cleaned region, where the extension region is distributed at the periphery of the dock region and is obtained by extending each edge point of the dock region by a second specified distance in the direction perpendicular to a corresponding edge; and a peripheral point determination unit, configured to obtain points having a cleanable feature in the extension region as the peripheral points of the dock region, where the cleanable feature is used to reflect the feature of a point that is located at the periphery of the dock region and is not cleaned due to the combined obstructions of the dock region and an obstacle.

In an embodiment of the present disclosure, for example, the cleanable feature includes one or more of the following: A width of an uncleaned region in at least one direction of a position where the point is located is greater than a maximum body width of the cleaning device; the point is an uncleaned non-obstacle point; all adjacent points of the point are uncleaned non-obstacle points; and the point is outside a preset no-go region, the preset no-go region including a carpet region, the dock region, and a self-defined safety region.

In an embodiment of the present disclosure, for example, the preset cleaning condition includes one or more of the following: A width of the region in which the clustering result is located in at least one direction is greater than the maximum body width of the cleaning device; an area of an uncleaned region in the region in which the clustering result is located is greater than or equal to a first specified area; an area of a cleaned region in the region in which the clustering result is located is less than or equal to a second specified area; and the region in which the clustering result is located includes at least a specified number of points at a distance from the obstacle greater than or equal to a third specified distance.

In an embodiment of the present disclosure, for example, the cleaning execution unit 604 is further configured to: perform a cross-region action on the cleanable region; clean the cleanable region when the cross-region action is successfully performed; return to the step of detecting whether the dock region in which the charging dock of the cleaning device is located has the intersection with the cleaned region when the cross-region action fails to be performed, so as to determine again whether the cleanable region is present around the dock region; and clean the cleanable region when it is determined again that the cleanable region is present around the dock region.

In an embodiment of the present disclosure, for example, the cleaning execution unit 604 is further configured to: acquire an uncleaned region within a specified distance range centered at the current position of the cleaning device; and clean the cleanable region if an area of the uncleaned region is greater than or equal to a third specified area.

The dock periphery cleaning apparatus 600 adopts the solution described in any one of the above embodiments and thus has all the technical effects described above, which will not be reiterated here.

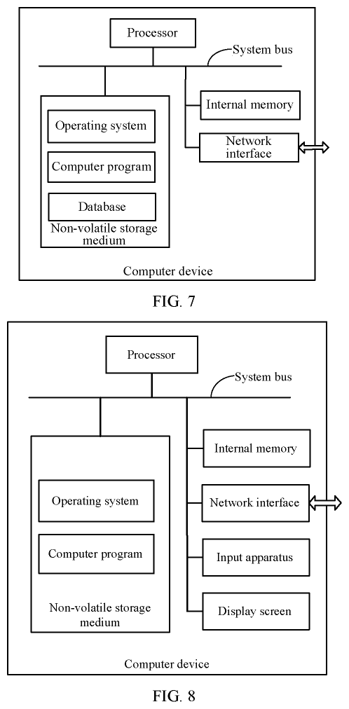

In addition, in an embodiment, the present disclosure provides a computer device. The computer device may be a server, and an internal structure diagram thereof may be shown in FIG. 7. The computer device includes a processor, a memory, a network interface, and a database that are connected through a system bus. The processor of the computer device is configured to provide computing and control capabilities. The memory of the computer device includes a non-volatile and/or volatile storage medium and an internal memory. The non-volatile storage medium stores an operating system, a computer program, and a database. The internal memory provides an environment for running the operating system and the computer program in the non-volatile storage medium. The network interface of the computer device is configured to communicate with an external client through a network connection. The computer program, when executed by the processor, may implement the dock periphery cleaning method according to any one of the above embodiments.

In an embodiment, the present disclosure further provides a computer device. The computer device may be a client, and an internal structure diagram thereof may be shown in FIG. 8. The computer device includes a processor, a memory, a network interface, a display screen, and an input apparatus that are connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for running the operating system and the computer program in the non-volatile storage medium. The network interface of the computer device is configured to communicate with an external server through a network connection. The computer program, when executed by the processor, may implement the dock periphery cleaning method according to any one of the above embodiments.

Any one of the above cleaning devices in the embodiments of the present disclosure may be any device having a cleaning function, such as a sweeper, a mopping machine, a floor-cleaning machine, a sweeping and mopping integrated machine, and a self-mobile vacuum cleaner. In addition, various forms may exist, for controlling the device having the cleaning function, including but not limited to:
(1) Mobile communication devices: Such devices feature a mobile communication function and are primarily intended to provide voice and data communication services. Such terminals include: smartphones (such as iPhone), multimedia phones, feature phones, and low-end phones.
(2) Ultra-mobile personal cleaning devices: Such devices, belonging to the category of personal computers, have computing and processing functions, and generally also incorporate a mobile Internet access feature. Such terminals include: PDAs, MIDs, and UMPC devices, such as iPad.
(3) Portable entertainment devices: Such devices can display and play multimedia content. Such devices include: audio and video players (such as iPod), handheld game consoles, e-books, smart toys, wearable devices, and portable vehicle-mounted navigation devices.
(4) Servers: Devices that provide a computing service. The server is composed of a processor, a hard disk, a memory, a system bus, and the like, and the server is similar to a general-purpose computer in architecture. However, since a highly reliable service needs to be provided, high requirements are imposed on aspects such as processing capability, stability, reliability, security, scalability, and manageability.
(5) Other electronic apparatuses with data interaction functions.

In addition, the embodiments of the present disclosure provide a computer-readable storage medium storing a computer-executable instruction. The computer-executable instruction is used for executing the following steps: detecting whether a dock region in which a charging dock of a cleaning device is located has an intersection with a cleaned region; and if the dock region has the intersection with the cleaned region, performing cleaning based on the peripheral points of the dock region.

It should be noted that the above functions or steps that can be implemented by the computer-readable storage medium or cleaning device may correspondingly refer to the relevant descriptions in the foregoing method embodiments. To avoid repetition, the functions or steps will not be elaborated here.

The technical solutions of the present disclosure are described in detail above with reference to the drawings. According to the technical solutions of the present disclosure, whether a cleaned region is a dock periphery region is identified by identifying whether the dock region in which the charging dock of the cleaning device is located has an intersection with the cleaned region. As a result, when the cleaned region is the dock periphery region, dock region peripheral points that can reflect whether an obstacle is present around the dock region are used to determine a cleanable region that is missed during cleaning due to the dual obstructions of the dock region and the obstacle near the dock region. Therefore, the method can automatically identify the cleanable region that is missed during cleaning due to the dual obstructions of the dock region and the obstacle near the dock region, thereby improving the adaptability of the cleaning device to the cleaning environment when there is an obstacle around the dock periphery, increasing the cleaning area of the cleaning device, and effectively improving the cleaning capability of the cleaning device. In addition, the overall cleaning effect is improved, and the user experience is enhanced.

It should be understood that the term “and/or” as used herein is merely a description of an association relationship between associated objects, indicating that three possible relationships may exist. For example, “A and/or B” can represent: the presence of A alone, the simultaneous presence of A and B, and the presence of B alone. In addition, the character “/” herein generally indicates an “or” relationship between the associated objects before and after.

It should be understood that although the terms “first”, “second”, and the like may be used in the embodiments of the present disclosure to describe regions, these regions should not be limited to these terms. These terms are only used to distinguish the regions from each other. For example, “first region” may also be referred to as “second region”, and similarly, “second region” may also be referred to as “first region”, without departing from the scope of the embodiments of the present disclosure.

Depending on the context, the term “if” as used herein may be interpreted as “when”, or “in response to determining”, or “in response to detecting”. Similarly, depending on the context, the phrases “if it is determined” or “if (a stated condition or event) is detected” may be interpreted as “when it is determined” or “in response to determining”, or “when (a stated condition or event) is detected” or “in response to detecting (a stated condition or event)”.

The terms used in the embodiments of the present disclosure are for the purpose of describing particular embodiments only and are not intended to limit the present disclosure. As used in the embodiments and the appended claims of the present disclosure, the singular forms “a”, “an”, and “the” are intended to include the plural forms as well, unless the context clearly indicates otherwise.

In the several embodiments according to the present disclosure, it should be understood that the disclosed system, apparatus, and method may be implemented in other manners. For example, the apparatus embodiments described above are merely illustrative. For example, the division of the units is merely a division based on logical function and may be implemented in other ways in an actual situation. For example, a plurality of units or components may be combined or integrated into another system, or some features may be ignored or not executed. In addition, the displayed or discussed coupling or direct coupling or communication connection between each other may be achieved through some interfaces, and indirect coupling or communication connection between the apparatuses or units may also be in electrical, mechanical, or other forms.

In addition, the various functional units in the embodiments of the present disclosure may be integrated into one processing unit, or the various units may physically exist separately, or two or more units may be integrated into one unit. The integrated unit may be implemented in the form of hardware, or in the form of hardware plus software functional unit.

Those of ordinary skill in the art can understand that all or some of the procedures of the methods in the above embodiments may be completed by a computer program instructing related hardware. The computer program may be stored in a non-volatile computer-readable storage medium, and when the computer program is executed, the procedures of the above method embodiments may be included. Any reference to a memory, a storage, a database, or another medium used in the embodiments according to the present disclosure may include a non-volatile and/or volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration and not limitation, RAM is available in various forms, such as static RAM (SRAM), dynamic RAM (DRAM), synchronous DRAM (SDRAM), double data rate SDRAM (DDRSDRAM), enhanced SDRAM (ESDRAM), synchlink (Synchlink) DRAM (SLDRAM), Rambus (Rambus) direct RAM (RDRAM), direct Rambus dynamic RAM (DRDRAM), and Rambus dynamic RAM (RDRAM).

The above embodiments are only used to illustrate the technical solutions of the present disclosure, but not to limit them; although the present disclosure has been described in detail with reference to the foregoing embodiments, those of ordinary skill in the art should understand that they can still modify the technical solutions recorded in the foregoing embodiments, or make equivalent substitutions for some of the technical features; and these modifications or substitutions do not make the essence of the corresponding technical solutions deviate from the spirit and scope of the technical solutions in the embodiments of the present disclosure, and shall fall within the protection scope of the present disclosure.

1. A dock periphery cleaning method, comprising:
detecting whether a dock region in which a charging dock of a cleaning device is located has an intersection with a cleaned region; and
if the dock region has the intersection with the cleaned region, performing cleaning based on peripheral points of the dock region.

2. The dock periphery cleaning method according to claim 1, wherein performing the cleaning based on the peripheral points of the dock region comprises:
determining a cleanable region based on the peripheral points of the dock region; and
cleaning the cleanable region according to a preset cleaning strategy.

3. The dock periphery cleaning method according to claim 2, wherein determining the cleanable region based on the peripheral points of the dock region comprises:
clustering the peripheral points of the dock region to obtain a plurality of clustering results; and
for each clustering result, if a region in which the clustering result is located satisfies a preset cleaning condition, determining the region in which the clustering result is located as the cleanable region, wherein the preset cleaning condition is used to reflect a feature of the region in which the clustering result is located when the region in which the clustering result is located is capable of being effectively cleaned by the cleaning device.

4. The dock periphery cleaning method according to claim 2, wherein determining the cleanable region based on the peripheral points of the dock region comprises:
connecting the peripheral points of the dock region directly in pairs to form a peripheral region; and
if a maximum width of the peripheral region is greater than a maximum body width of the cleaning device, determining the peripheral region as the cleanable region.

5. The dock periphery cleaning method according to claim 1, wherein detecting whether the dock region in which the charging dock of the cleaning device is located has the intersection with the cleaned region comprises one of:
detecting, when cleaning of a first region is completed, whether the first region has an intersection with the dock region in which the charging dock of the cleaning device is located;
detecting, when cleaning of a plurality of second regions is completed, whether at least one second region has an intersection with the dock region in which the charging dock of the cleaning device is located; or
detecting, when cleaning of a third region comprising a specified point is completed, whether the third region has an intersection with the dock region in which the charging dock of the cleaning device is located, wherein the specified point is a point outside the dock region and whose distance from an edge point of the dock region is less than or equal to a first specified distance.

6. The dock periphery cleaning method according to claim 5, wherein a region that has a possibility of being missed during cleaning or a region that is missed during cleaning in a historical cleaning process is selected manually as the first region by a user.

7. The dock periphery cleaning method according to claim 5, wherein all cleaned regions in a current cleaning process are set as the first region.

8. The dock periphery cleaning method according to claim 3, wherein if the dock region has the intersection with the cleaned region, before clustering the peripheral points of the dock region, the method further comprises:
determining an extension region of the dock region based on edge points of the dock region, wherein the extension region is distributed at a periphery of the dock region and is obtained by extending each edge point of the dock region by a second specified distance in a preset direction; and
obtaining points having a cleanable feature in the extension region as the peripheral points of the dock region, wherein the cleanable feature is used to reflect a feature of a point that is located at the periphery of the dock region and is not cleaned due to combined obstructions of the dock region and an obstacle.

9. The dock periphery cleaning method according to claim 8, wherein the preset direction comprises:
a direction perpendicular to a corresponding edge; or
a direction that is offset by 30° clockwise from a direction perpendicular to the corresponding edge.

10. The dock periphery cleaning method according to claim 8, wherein the cleanable feature comprises one or more of the following:
a width of an uncleaned region in at least one direction of a position where the point is located being greater than a maximum body width of the cleaning device;
the point being an uncleaned non-obstacle point;
all adjacent points of the point being uncleaned non-obstacle points; and
the point being outside a preset no-go region, the preset no-go region comprising a carpet region, the dock region, and a self-defined safety region.

11. The dock periphery cleaning method according to claim 3, wherein the preset cleaning condition comprises one or more of the following:
a width of the region in which the clustering result is located in at least one direction being greater than a maximum body width of the cleaning device;
an area of an uncleaned region in the region in which the clustering result is located being greater than or equal to a first specified area;
an area of a cleaned region in the region in which the clustering result is located being less than or equal to a second specified area; and
the region in which the clustering result is located comprising at least a specified number of points at a distance from an obstacle greater than or equal to a third specified distance.

12. The dock periphery cleaning method according to claim 2, wherein cleaning the cleanable region according to the preset cleaning strategy comprises:
performing a cross-region action on the cleanable region;
cleaning the cleanable region when the cross-region action is successfully performed;
returning to a step of detecting whether the dock region in which the charging dock of the cleaning device is located has the intersection with the cleaned region when the cross-region action fails to be performed, so as to determine again whether the cleanable region is present around the dock region; and
cleaning the cleanable region when it is determined again that the cleanable region is present around the dock region.

13. The dock periphery cleaning method according to claim 12, wherein cleaning the cleanable region when it is determined again that the cleanable region is present around the dock region comprises:
acquiring an uncleaned region within a specified distance range centered at a current position of the cleaning device; and
cleaning the cleanable region if an area of the uncleaned region is greater than or equal to a third specified area.

14. A cleaning device, comprising:
a processor; and a memory communicatively connected to the processor,
wherein the memory stores instructions executable by the processor, and the processor is configured to:
detect whether a dock region in which a charging dock of a cleaning device is located has an intersection with a cleaned region; and
if the dock region has the intersection with the cleaned region, perform cleaning based on peripheral points of the dock region.

15. The cleaning device according to claim 14, wherein the processor is configured to:
determine a cleanable region based on the peripheral points of the dock region; and
clean the cleanable region according to a preset cleaning strategy.

16. The cleaning device according to claim 15, wherein the processor is configured to:
cluster the peripheral points of the dock region to obtain a plurality of clustering results; and
for each clustering result, if a region in which the clustering result is located satisfies a preset cleaning condition, determine the region in which the clustering result is located as the cleanable region, wherein the preset cleaning condition is used to reflect a feature of the region in which the clustering result is located when the region in which the clustering result is located is capable of being effectively cleaned by the cleaning device.

17. The cleaning device according to claim 15, wherein the processor is configured to:
connect the peripheral points of the dock region directly in pairs to form a peripheral region; and
if a maximum width of the peripheral region is greater than a maximum body width of the cleaning device, determine the peripheral region as the cleanable region.

18. The cleaning device according to claim 14, wherein the processor is configured to perform one of:
detecting, when cleaning of a first region is completed, whether the first region has an intersection with the dock region in which the charging dock of the cleaning device is located;
detecting, when cleaning of a plurality of second regions is completed, whether at least one second region has an intersection with the dock region in which the charging dock of the cleaning device is located; or
detecting, when cleaning of a third region comprising a specified point is completed, whether the third region has an intersection with the dock region in which the charging dock of the cleaning device is located, wherein the specified point is a point outside the dock region and whose distance from an edge point of the dock region is less than or equal to a first specified distance.

19. The cleaning device according to claim 18, wherein a region that has a possibility of being missed during cleaning or a region that is missed during cleaning in a historical cleaning process is selected manually as the first region by a user.

20. A computer-readable storage medium storing computer-executable instructions, wherein the computer-executable instructions are used for performing a dock periphery cleaning method comprising:
detecting whether a dock region in which a charging dock of a cleaning device is located has an intersection with a cleaned region; and
if the dock region has the intersection with the cleaned region, performing cleaning based on peripheral points of the dock region.
